(19) United States
(12) Patent Application Publication
(10) Pub. No.: US 2012/0284300 A1
(43) Pub. Date: Nov. 8, 2012

(54) Automatically Configured Data Search Function

(76) Inventor: Thomas Sachson, Menlo Park, CA (US)

(21) Appl. No.: 13/464,953

(22) Filed: May 5, 2012

Related U.S. Application Data
(60) Provisional application No. 61/482,727, filed on May 5, 2011.

(51) Int. Cl. G06F 17/30

(52) U.S. Cl. 707/769; 707/E17.014

(57) ABSTRACT

The subject invention describes and relates generally to searching databases and content sharing systems and associated methods of operation. Specifically, the subject invention relates to a “one click” search function that is accessible by a plurality of entities over a network such as the Internet and engages in the automatic creation of search parameters drawn from the pre-formatted, pre-populated, categorized data in a pre-existing dataset and having these automatically generated search parameters that mirror such pre-formatted, pre-populated, categorized data in a pre-existing dataset effect a search for items with similar format and categorized properties to the pre-existing dataset, thereby obviating the need for the searcher to manually construct a set of search terms in order to find similar datasets to the pre-existing dataset.

### CROSS-REFERENCE

This application claims the benefit of U.S. Provisional Application No. 61/482,727, by Sachson, entitled Automatically Configured Data Search Function, filed on May 5, 2011, the disclosures of such application is incorporated herein by reference.

### BACKGROUND OF THE INVENTION

Numerous web data aggregation platforms (social networks, professional networks, genealogy databases, health profiles, personal timelines, corporate records, accounting entries, financial records, fictional narratives, non-fictional narratives, news distributors) require one or more users to input data into corresponding data fields for recordation and associated machine search purposes. An example might be a personal timeline construction website where a user (Person A) inputs their personal data in data entry blocks (e.g., data inserted into categorized fields, such as day of birth, residence locations, jobs held, etc.) and such data is used to create a particular chronological profile of the Person A's life according to certain periods of time. In this case, if one wished to do a search for similar blocks of data relating to someone other than Person A, then such a search would be effected by a user of the timeline website manually constructing (e.g., inputting into various search fields) a set of search terms and/or items into a search engine (by one or more of key words, Boolean logic, selected categories, date parameters, or analogous search event segmentation actions), where after a query of the data being searched there is rendered a list of possible matches for the searcher to review. However, these method of searching require that the searcher manually create (e.g., physically typing various key words, etc. into the search engine) the search parameters prior to the search being effected, which might include typing in key words, pairing certain key words to certain categories, selecting certain categories to search, etc. into a dedicated search engine.

### SUMMARY

The subject invention describes and relates generally to searching databases and content sharing systems and associated methods of operation. Specifically, the subject invention relates to a “one click” search function that is accessible by a plurality of entities over a network such as the Internet and engages in the automatic, computer generated creation of search parameters drawn from the pre-formatted, pre-populated, categorized data in a pre-existing dataset and having these automatically generated search parameters that mirror such pre-formatted, pre-populated, categorized data in a pre-existing dataset effect a search for items with similar format and categorized properties to the pre-existing dataset, thereby obviating the need for the searcher to manually construct a set of search terms in order to find similar datasets to the pre-existing dataset.

Further, the method and apparatus pertaining to this invention may comprise a tangible machine readable medium storing instructions that, when executed by a computing device, cause the computing device to perform a method, which may comprise creating one or more data sets accessible by a plurality of entities over a network such as the Internet and engage in the rapid, computer-generated creation (the “one click” creation) of search terms and parameters that are used by the search engine utilized by the searcher to find target information in a particular dataset based upon and mirroring of the form, content, structure, and substance of a different dataset that served as a structural, contextual, and content model for the “one click” search of the searcher.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The features, aspects and advantages of the disclosed and claimed subject matter of the present application are set forth with particularity in the appended claims. A better understanding of the aspects, features, and advantages of the disclosed and claimed subject matter will be obtained by reference to the following detailed description that sets forth what are meant to be only illustrative embodiments and not limiting disclosures, in which the principles of the Invention are utilized, and the accompanying drawings of which:

FIG. 1 illustrates a block diagram of the status quo search user interface and technology deployed in existing online environments (e.g., web pages) which contemplates the use of one or more form fields (to be inserted with text, but could also take the form of tick boxes, drop down boxes, or analogous) that the user manually completes and configures, and when complete submits the same for purposes of searching the appropriate affiliated dataset.

FIG. 2 illustrates a block diagram of the most basic embodiment of the current invention showing to the left a pre-existing, structured dataset pre-populated with data elements that has associated with it a single “one click” search button (or similar user interface as represented by the small diamond in the lower right hand corner of the box on the left) that when clicked generates an automatic computer generated search user interface that summarizes the aspects of the search to be performed, with such aspects substantially (content, priority, context, and structure) mirroring the data found in the pre-existing, structured dataset pre-populated with data elements identified in the boxes to the left. These automatically generated search criteria can then be acted upon by the user performing the search by clicking the search button associated therein (in this example, represented by the smaller box in the lower right corner of the right hand box) with generated search result streams being presented to the search user.

### DETAILED DESCRIPTION

Aspects, features and advantages of the disclosed and claimed subject matter can be seen in the description herein of an automatically configured, (computer generated) data search that represents a more efficient manner of searching such datasets than is observed in the prior art. Specifically, the present invention exemplifies a machine enabled mechanism whereby the searcher instructs the search agent to automatically construct a set of search parameters (key words, categories, ranges, etc.) based upon a pre-existing data set that the searcher has already identified as being relevant to the search. By way of example, if a searcher is viewing the profile (data set) relating to Person A in the timeline example above on a web site, and such searcher wanted to find other users with similar data sets (when they were born, where they have lived, what jobs they have had, etc.), the searcher would merely request of the web site search agent to do a search based on the data profile already provided by Person A. In this case, the current invention would provide to the search engine automatically pre-propagate search terms, fields, parameters, and analogous items, and do so in a manner mirroring as much as practical the form and structure of the pre-existing dataset represented by the data available in Person A's profile, and to do so in manner that it would be positioned to deliver a search (and results) that sought to find similar persons with similar life experiences to that person represented by the mirrored pre-existing dataset. This way, the invention enables a searcher to do a “one click” search for similar persons to Person A without having to re-input or manually construct any elements of the new search.

In the timeline example, Person A may have described themselves using a data set pertaining to the year 1966, with key words and/or fields and/or categories linked to “Los Angeles”, “Actor”, “UCLA” (these items and others being a pre-existing dataset, perhaps represented by a “bubble” on a timeline). If a searcher wanted to find similar datasets corresponding to other persons they could use the current invention by simply clicking one button associated with this pre-existing dataset and the invention would port all of the pre-existing dataset characteristics into its own search engine and nm the search based upon such automatically imported data points. As such, the searcher could very quickly and accurately find similar datasets to the preexisting dataset.

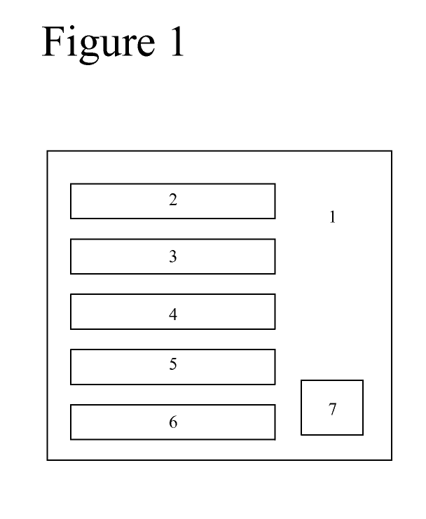

Turning to the figures, FIG. 1 illustrates a block diagram of the status quo search user interface and technology deployed in existing online environments (e.g., web pages) which contemplates the use of one or more form fields (to be inserted with text, but could also take the form of tick boxes, drop down boxes, or analogous) that the user manually completes and configures, and when complete submits the same via the use of a search button for purposes of searching the appropriate affiliated dataset. In the example provided in FIG. 1, the block diagram shows a typical search function 1 where one or more search boxes represented by boxes 2, 3, 4, 5, 6 (e.g., pertaining to search terms relating to persons, things, places, times, and actions) are incorporated. In addition, there is usually a “search” button 7 that launches the search query once the search parameters have been manually specified.

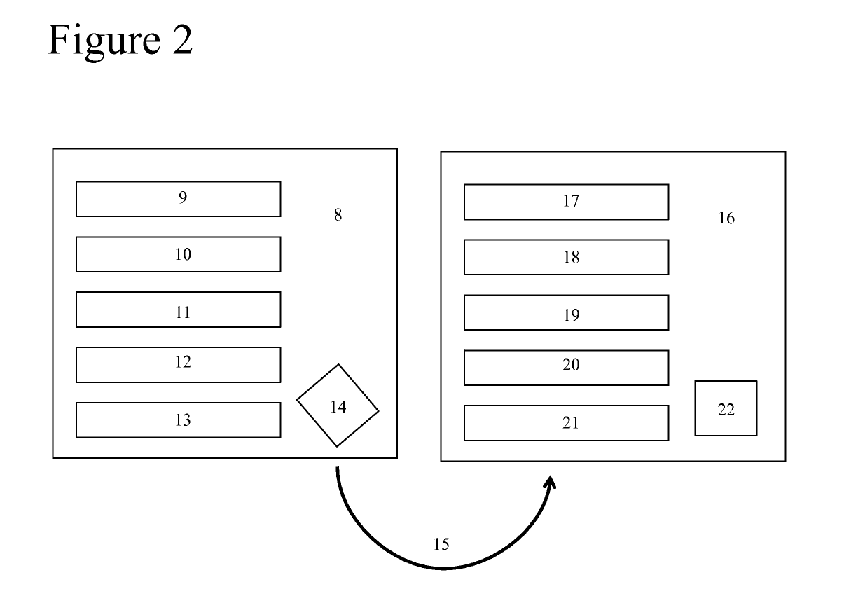

FIG. 2 illustrates a block diagram of the most basic embodiment of the current invention showing to the left a pre-existing, structured dataset 8 pre-populated with data elements represented by boxes 9, 10, 11, 12, 13 (e.g., pertaining to dataset items relating to persons, things, places, times, and actions) that has associated with it a single “one click” search button 14 (or similar user interface as represented by the small diamond in the lower right hand corner of the box on the left) that when clicked produces 15 an automatic computer generated search user interface 16 that summarizes the aspects of the search to be performed, with such aspects substantially (content, priority, context, and structure) mirroring the data found in the pre-existing, structured dataset pre-populated with data elements identified in the boxes to the left. These mirrored, automatically generated search criteria (represented by boxes 17, 18, 19, 20, 21 and in the current example pertaining closely to search items relating to persons, things, places, times, and actions) can then be acted upon by the user performing the search by clicking the search button 22 associated therein (in this example, represented by the smaller box in the lower right corner of the right hand box) with generated search result streams being presented to the search user.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

Moreover, this system and method could be applied to any number of database platforms in use today, whether they be found in the content of social networks, financial databases, or otherwise.

What is claimed is:

1. A method of performing a “one click” search function that is accessible by a plurality of entities over a network such as the Internet and engages in the automatic creation of search parameters drawn from and substantially mirroring the data structure in a pre-existing dataset within a social network and having these automatically generated search parameters effect a search for items with similar properties to the pre-existing dataset within a social network and thereafter delivering search results to the searcher, thereby obviating the need for the searcher to manually construct a set of search terms in order to find similar datasets to the pre-existing dataset within a social network.

2. A system of performing a “one click” search function that is accessible by a plurality of entities over a network such as the Internet and engages in the automatic creation of search parameters drawn from and substantially mirroring the data structure in a pre-existing dataset within a social network and having these automatically generated search parameters effect a search for items with similar properties to the pre-existing dataset within a social network and thereafter delivering search results to the searcher, thereby obviating the need for the searcher to manually construct a set of search terms in order to find similar datasets to the pre-existing dataset within a social network.

3. A method as set forth in claim 1 wherein the functions are not performed in the context of a social network, but instead in the context of a professional network.

4. A system as set forth in claim 2 wherein the functions are not performed in the context of a social network, but instead in the context of a professional network.

5. A method as set forth in claim 1 wherein the functions are not performed in the context of a social network, but instead in the context of a genealogy data network.

6. A system as set forth in claim 2 wherein the functions are not performed in the context of a social network, but instead in the context of a genealogy data network.

7. A method as set forth in claim 1 wherein the functions are not performed in the context of a social network, but instead in the context of a health data network.

8. A system as set forth in claim 2 wherein the functions are not performed in the context of a social network, but instead in the context of a health data network.

9. A method as set forth in claim 1 wherein the functions are not performed in the context of a social network, but instead in the context of a personal timeline network.

10. A system as set forth in claim 2 wherein the functions are not performed in the context of a social network, but instead in the context of a personal timeline network.

11. A method as set forth in claim 1 wherein the functions are not performed in the context of a social network, but instead in the context of a corporate record network.

12. A system as set forth in claim 2 wherein the functions are not performed in the context of a social network, but instead in the context of a corporate record network.

13. A method as set forth in claim 1 wherein the functions are not performed in the context of a social network, but instead in the context of a accounting data network.

14. A system as set forth in claim 2 wherein the functions are not performed in the context of a social network, but instead in the context of a accounting data network.

15. A method as set forth in claim 1 wherein the functions are not performed in the context of a social network, but instead in the context of a financial data network.

16. A system as set forth in claim 2 wherein the functions are not performed in the context of a social network, but instead in the context of a financial data network.

17. A method as set forth in claim 1 wherein the functions are not performed in the context of a social network, but instead in the context of a narrative data network.

18. A system as set forth in claim 2 wherein the functions are not performed in the context of a social network, but instead in the context of a narrative data network.

19. A tangible machine readable medium storing instructions that, when executed by a computing device, cause the computing device to perform a method of operating a computer-implemented application creation system comprising:
a. performing a “one click” search function that is accessible by a plurality of entities over a network such as the Internet and engages in the automatic creation of search parameters drawn from and substantially mirroring the data structure in a pre-existing dataset within a particular network and having these automatically generated search parameters effect a search for items with similar properties to the pre-existing dataset within a particular network and thereafter delivering search results to the searcher, thereby obviating the need for the searcher to manually construct a set of search terms in order to find similar datasets to the pre-existing dataset within a particular network.

20. A networked apparatus comprising:
a. a memory;
b. a processor;
c. a communicator;
d. a display; and
e. a suite of software capable of performing a “one click” search function that is accessible by a plurality of entities over a network such as the Internet and engages in the automatic creation of search parameters drawn from and substantially mirroring the data structure in a pre-existing dataset within a particular network and having these automatically generated search parameters effect a search for items with similar properties to the pre-existing dataset within a particular network and thereafter delivering search results to the searcher, thereby obviating the need for the searcher to manually construct a set of search terms in order to find similar datasets to the pre-existing dataset within a particular network.
